(19) United States
(12) Patent Application Publication
(10) Pub. No.: US 2026/0300131 A1
(43) Pub. Date: Oct. 1, 2026

(54) CODE ANALYSIS TOOL TO DETERMINE POTENTIALLY IDENTICAL FUNCTION CALLS BASED ON HASH VALUES

(71) Applicant: SAP SE, Walldorf (DE)

(72) Inventor: Michael GOEDECKE, Thornton (DE)

(21) Appl. No.: 19/095,500

(22) Filed: Mar. 31, 2025

(51) Int. Cl. G06F 11/3604

(52) U.S. Cl. CPC G06F 11/3612

(57) ABSTRACT

An application data store may contain advanced programming language code that includes function calls. A computer processor of a code analysis tool may access the advanced programming language code from the application data store. A first function call in the advanced programming language code is identified and a first hash value for the first function call is calculated (e.g., using SHA-1, MD5, or any other appropriate algorithm). The hash values might be calculated, for example, based on input, change, and/or output parameters of the function calls. The code analysis tool can then automatically determine that a second function call in the advanced programming language code is potentially identical to the first function call based on the first hash value and a second hash value calculated for the second function call. An indication of the determination is then transmitted to a user in connection with a trace tool.

### BACKGROUND

An enterprise may use an advanced application programming language to allow for the mass-processing of data in business applications. In some cases, the programming language may let an enterprise customize Enterprise Resource Planning (“ERP”) and/or cloud-based systems to better meet their needs. The programming language may be a multi-paradigm programming language, meaning programmers can utilize procedural, object-oriented, and other programming principles including function calls.

Such code for a large enterprise may be written by tens of thousands of programmers over many decades for various business applications. The code may be re-used internally and externally to create new applications. Performance optimization of code, including enterprise code and customer code, is one of the most important tasks in application development, comprehensive and personalized customer service delivery provide support across an industry or line-of-business, etc. When new business applications are created, performance problems often occur when existing code is re-used. For a developer who reuses existing code, the code basically a “black box” and they will not know which function calls are being made. When developers create new applications, they understandably focus on making the code functionally correct, instead of whether the calculations in the existing code are necessary. It may not even be known if the function called does anything or if the same results are being calculated over and over again.

Some trace tools exist to help identify find poorly performing algorithms in a very limited context, such as a Structured Query Language (“SQL”) environment. For example, identical SQL calls to a database may be identified (which is relatively simple because SQL conditions don’t have a complex data structure). There is no tool that lets developers know if the functions called in an application have identical input, changing, and output parameters. This can only be determined by manual debugging, which is an extremely cumbersome, expensive, and error-prone task. For example, FIGS. 1 and 2 illustrate application function calls. In particular, FIG. 1 shows application code 100 that includes a substantial number of function calls 100 making it difficult to identify which ones are identical (e.g., “function A call” in FIG. 1). Moreover, FIG. 2 illustrates an application code 200 function call tree or hierarchy 210 making manual debugging even more difficult to perform.

Implementing a tool similar to the SQL approach for an advanced programming language would require an enormous amount of memory. During execution of a batch program for each data record there may be hundreds (if not thousands) of functions being called. This can result in hundreds of millions (if not billions) of calls when processing millions of data records.

It would therefore be desirable to provide function call analysis of application code in a secure, automatic, and efficient manner.

### SUMMARY

According to some embodiments, methods and systems may include an application data store that contains advanced programming language code that includes function calls. A computer processor of a code analysis tool accesses the advanced programming language code from the application data store. A first function call in the advanced programming language code is identified and a first hash value for the first function call is calculated (e.g., using SHA-1, MD5, or any other appropriate algorithm). The hash values might be calculated, for example, based on input, change, and/or output parameters of the function calls. The code analysis tool can then automatically determine that a second function call in the advanced programming language code is potentially identical to the first function call based on the first hash value and a second hash value calculated for the second function call. An indication of the determination is then transmitted to a user in connection with a trace tool.

Some embodiments comprise: means for accessing, by a computer processor of code analysis tool, advanced programming language code that includes function calls from an application data store; means for identifying a first function call in the advanced programming language code; means for calculating a first hash value for the first function call; means for automatically determining that a second function call in the advanced programming language code is potentially identical to the first function call based on the first hash value and a second hash value calculated for the second function call; and means for transmitting an indication of the determination to a user in connection with a trace tool.

Some technical advantages of some embodiments disclosed herein are improved systems and methods to provide function call analysis of application code in a secure, automatic, and efficient manner.

### BRIEF DESCRIPTION OF THE DRAWINGS

FIG. 3 is a high-level system architecture associated with a function call analysis environment in accordance with some embodiments.

FIG. 4 is a function call analysis method according to some embodiments.

FIG. 5 is an illustration of a function call analysis using an input parameter hash value in accordance with some embodiments.

FIG. 6 is an illustration of a function call analysis using a change parameter hash value according to some embodiments.

FIG. 7 is an illustration of a function call analysis using an output parameter hash value in accordance with some embodiments.

FIG. 8 is an illustration of a function call analysis using input, change, and output parameter hash values according to some embodiments.

FIG. 9 is an illustration of likely identical function calls in accordance with some embodiments.

FIG. 10 is a function call analysis results display in accordance with some embodiments.

FIG. 11 is an apparatus or platform according to some embodiments.

FIG. 12 is a portion of a code analysis data store in accordance with some embodiments.

FIG. 13 illustrates a tablet computer according to some embodiments.

FIG. 14 is an operator or administrator display in accordance with some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

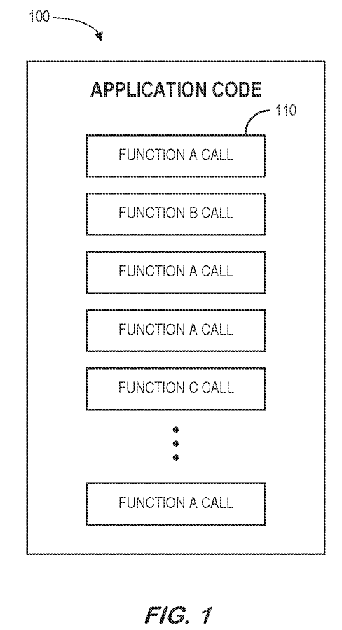

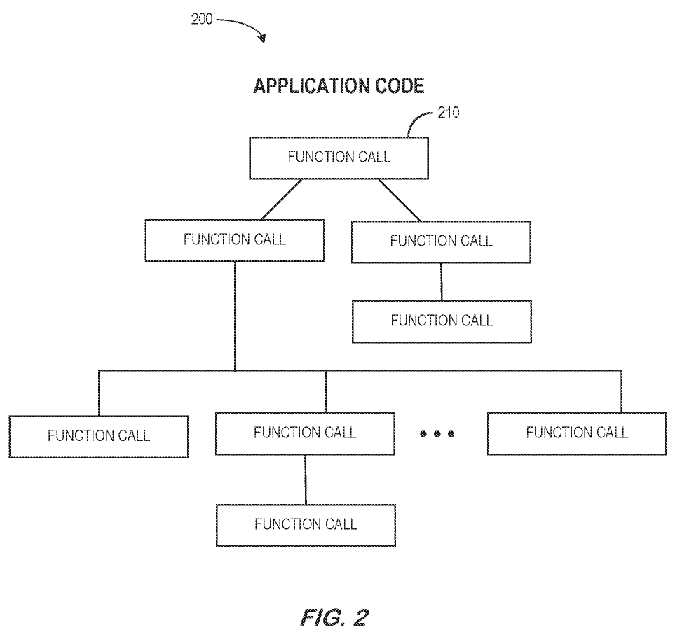

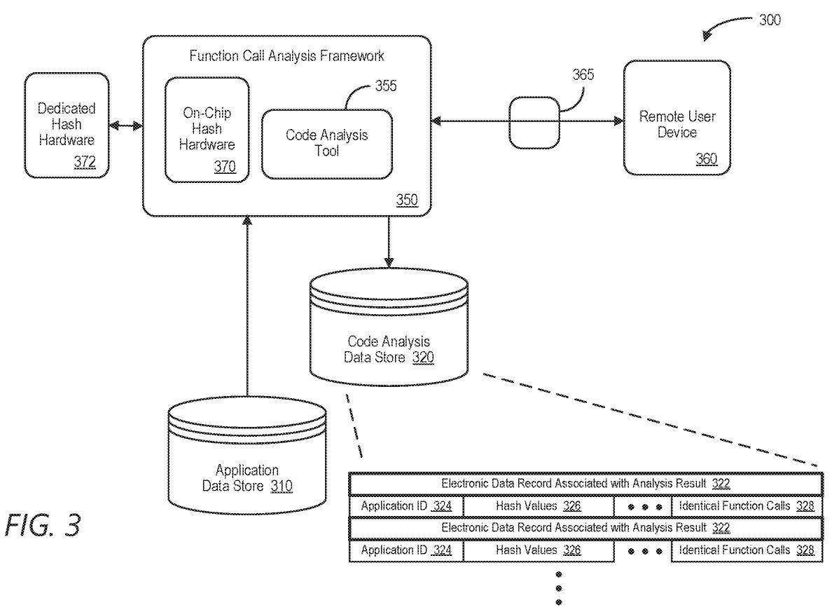

FIG. 3 is a high-level software analysis system architecture in accordance with some embodiments. In particular, the system 300 includes a function call analysis framework 350 that may access information in an application store 310 that contains advanced programming language code that contains function calls. The function call analysis framework 350 may also store information into other data stores, such as a code analysis data store 320 containing information about a code analysis initiated by a code analysis tool 355 (e.g., a set of electronic records associated with analysis results 322, each record including, for example, one or more hash values 324, hash values 326, potentially identical function calls 328, etc.), and utilize a code analysis tool 355 to view, analyze, and/or update electronic records.

As used herein, the phrase “hash value” may refer to any mathematical function that maps data of any size to a fixed-size hash. Some examples of hash functions include a Secure Hash Algorithm 1 (“SHA-1”) algorithm that produces a 20-byte hash message digest value. Other examples include, a Message Digest 5 (“MD5”) algorithm, a Cyclic Redundancy Check 32 (“CRC32”) algorithm, a Research and development in Advanced Communications technologies in Europe (“RACE”) Message Digest 160 (“RACEMD160”), a Tiger Tree Hash (“TTH”) algorithm, etc. In some embodiments hash value calculations may be facilitated via on-chip hash hardware 370 and/or of-chip dedicated hash hardware 372. For example, a set of extensions to the x86 and Advanced Reduced Instruction Set Computer (“RISC”) architecture (“ARM) instruction set architecture may support hardware acceleration of the SHA family.

The function call analysis framework 350 may also exchange information with a remote user device 360 (e.g., via a firewall 365). According to some embodiments, an interactive Graphical User Interface (“GUI”) platform of the function call analysis framework 350 may facilitate the creation and review of analysis results, recommendations, alerts, and/or the display of results via one or more remote administrator computers (e.g., to summarize system 300 performance) and/or the remote user device 360. For example, the first remote user device 360 may transmit annotated and/or updated information to the function call analysis framework 350. Based on the updated information, the function call analysis framework 350 may adjust data in the code analysis data store 320. Note that the function call analysis framework 350 and/or any of the other devices and methods described herein might be associated with a third party, such as a vendor that performs a service for an enterprise.

The function call analysis framework 350 and/or the other elements of the system 300 might be, for example, associated with a Personal Computer (“PC”), laptop computer, smartphone, an enterprise server, a server farm, and/or a database or similar storage devices. According to some embodiments, an “automated” function call analysis framework 350 (and/or other elements of the system 300) may facilitate the automated access and/or update of electronic records in the data stores 310, 320 and/or the management or reporting of analysis results. As used herein, the term “automated” may refer to, for example, actions that can be performed with little (or no) intervention by a human.

Devices, including those associated with the function call analysis framework 350 and any other apparatus described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The function call analysis framework 350 may store information into and/or retrieve information from the application store 310 and/or the code analysis data store 320, which may be locally stored or reside remote from the function call analysis framework 350. As will be described further, the application store 310 may be used by the function call analysis framework 350 in connection with an interactive user interface to access and update electronic records. Although a single function call analysis framework 350 is shown in FIG. 3, any number of such devices may be included. Moreover, various devices described herein might be combined according to embodiments of the present invention. For example, in some embodiments, the function call analysis framework 350 and application store 310 might be co-located and/or may comprise a single apparatus.

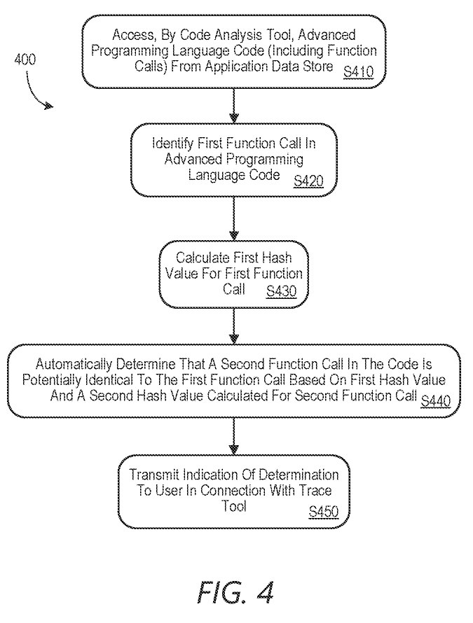

The elements of the system 300 may work together to perform the various embodiments of the present invention. Note that the system 300 of FIG. 3 is provided only as an example, and embodiments may be associated with additional or fewer elements or components. According to some embodiments, the elements of the system 300 automatically transmit information associated with an interactive user interface display over a distributed communication network. FIG. 4 is a function call analysis method 400 that might be performed, for example, by the system 300 of FIG. 3 according to some embodiments. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S410, a computer processor of code analysis tool access advanced programming language code that includes function calls from an application data store. By way of examples only, the phrase “advanced programming language code” might refer to Advanced Business Application Programming (“ABAP”), a method’s call of an object, a Pascal function or procedures, a C programming language function, object-oriented programming methods which are part of an object, or any similar programming language.

At S420, a first function call in the advanced programming language code is identified. A first hash value for the first function call can then be calculated at S430. At S440, the system automatically determines that a second function call in the advanced programming language code is potentially identical to the first function call based on the first hash value and a second hash value calculated for the second function call. The hash values might be calculated, for example, based on input, change, and/or output parameters of the function calls (or any combination of those parameters). Note that each of the input, change, and output parameters might comprise data structures with multiple fields. Moreover, each parameter (input, changing, or output) might be several kilobytes. According to some embodiments, the hash values are calculated using dedicated hardware associated with the computer processor. The dedicated hardware might be, for example, associated with password encryption. At S450, the system transmits an indication of the determination to a user in connection with a trace tool.

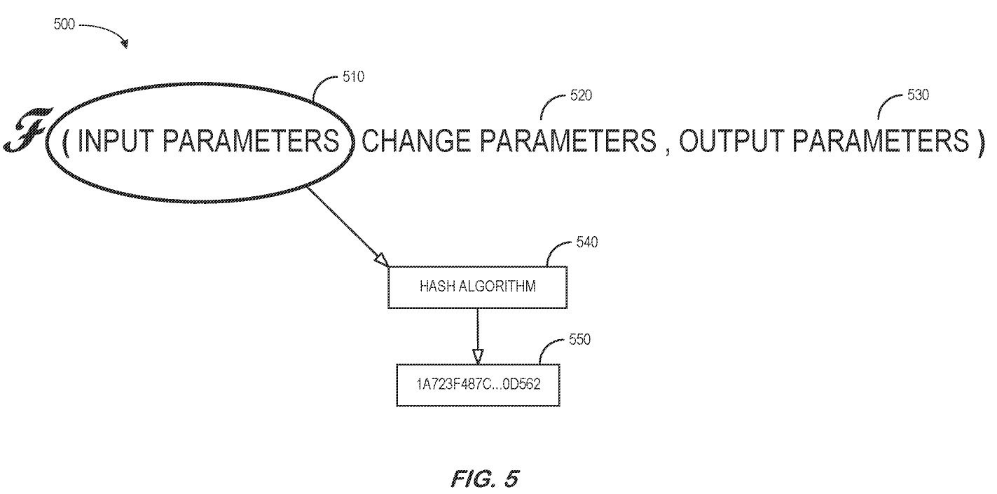

FIG. 5 is an illustration 500 of a function call analysis using an input parameter hash value in accordance with some embodiments. As shown, a function call includes input parameters 510, change parameters 520, and output parameters 530. The input parameters 510 are provided to a hash algorithm 540 which generates a fixed-length hash value 550 (e.g., “1A723F487C ... 0D562”). If two function calls have identical hash values 550, it is highly likely that the function call input parameters 510 are the same. Note that hash value 550 memory consumption is small – otherwise comparisons would require an enormous amount of memory. By calculating a hash value 550 for all of the input parameters 510, the memory consumption is drastically reduced. Moreover, the tool’s implementation is simplified substantially. Such a trace could easily be used in a productive environment to analyze applications, whereas without the hash values 550 memory consumption would explode.

Note that hash values 550 are not “perfectly unique” for a set of input parameters 510. That is, under very rare circumstances two different inputs into the has algorithm 540 could, in theory, output the same hash value 550. Because this tool is used for performance optimization, a minor likelihood of such an occurrence may be acceptable (as compared to an accounting tool where a mistake might have more substantial consequences). Such problems are extremely rare, such as in SHA algorithms, and finding two sets of input parameters 510 that create the same hash value 550 is basically impossible.

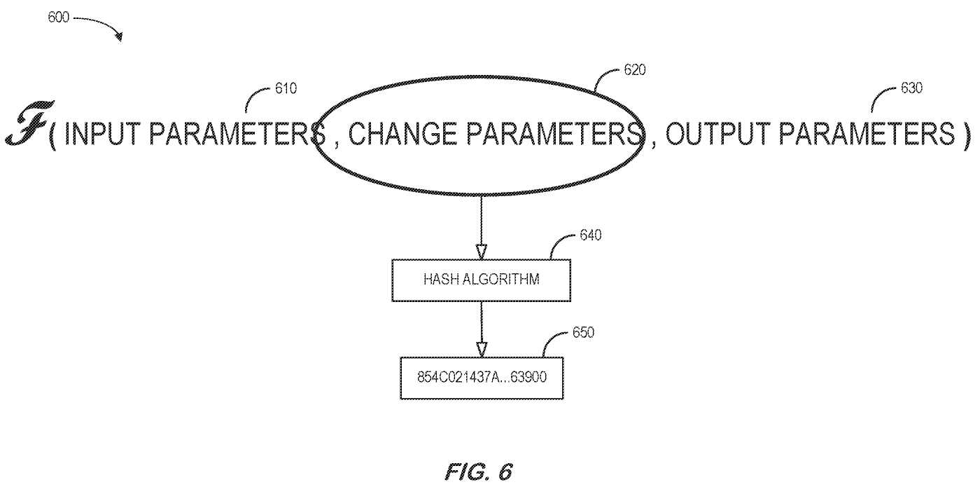

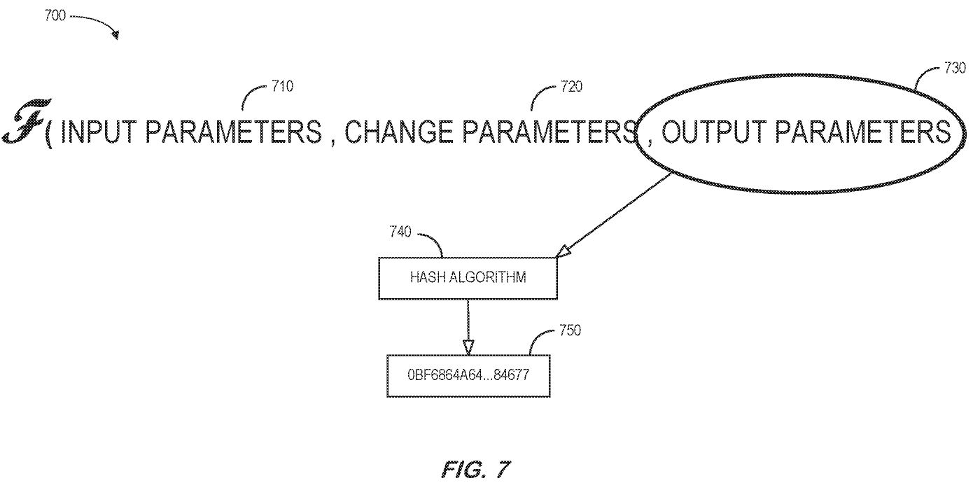

Note that a function call does not change the input parameter 510. In some cases, however, it might be desirable to provide a parameter that can be updated by a function call. For example, a “123 Main Street” parameter might be updated to “123 Main St.” to enhance database consistency. FIG. 6 is an illustration 600 of a function call analysis using a “change” parameter hash value according to some embodiments. As before, a function call includes input parameters 610, change parameters 620, and output parameters 630. The change parameters 620 are provided to a hash algorithm 640 which generates a fixed-length hash value 650 (e.g., “854C021437A...63900”). If two function calls have identical hash values 650, it is highly likely that the function call change parameters 620 are the same. Similarly, FIG. 7 is an illustration 700 of a function call analysis using an “output” parameter hash value in accordance with some embodiments. Again, a function call includes input parameters 710, change parameters 720, and output parameters 730. The output parameters 730 are provided to a hash algorithm 740 which generates a fixed-length hash value 750 (e.g., “0BF6864A64...84677”). If two function calls have identical hash values 750, it is highly likely that the function call output parameters 730 are the same.

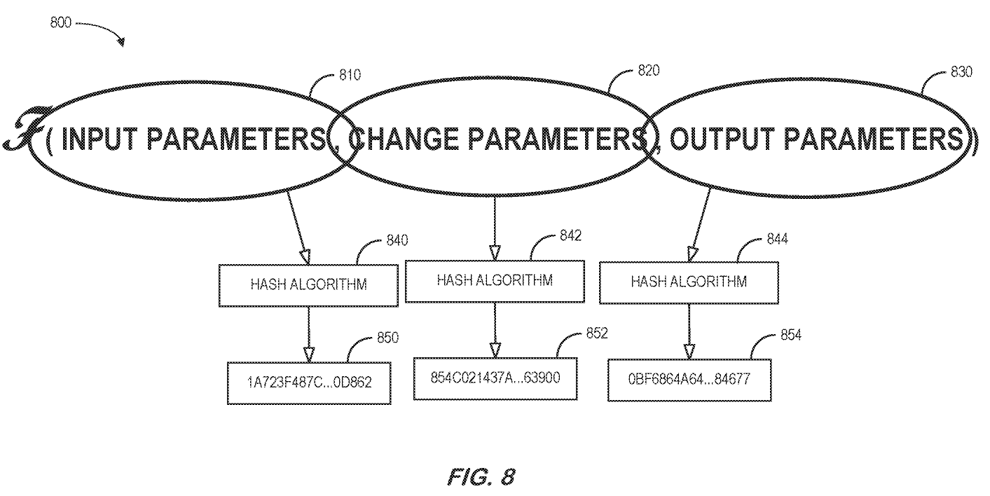

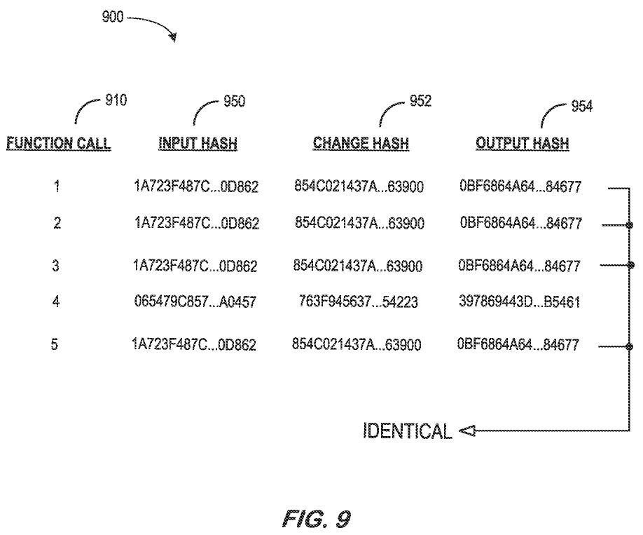

Some embodiments may calculate three hash values. FIG. 8 is an illustration 800 of a function call analysis using input, change, and output parameter hash values according to some embodiments. As shown, a function call includes input parameters 810, change parameters 820, and output parameters 830. The input parameters 810, change parameters 820, and output parameters 830 are all provided to hash algorithms 840, 842, 844 to generate three different fixed-length hash value 850, 852, 854. If two function calls have identical hash values 850, 852, 854, it is highly likely that the function calls are the same. For example, FIG. 9 is an illustration 900 of likely identical function calls in accordance with some embodiments. A set of function calls 910 have an input hash 950, a change hash 952, and an output hash 954. The hashes 950, 952, 954 are then used to identify identical function calls 910 (e.g., function calls 910 “1,” “2,” “3,” and “5”). In still another embodiment, the input parameters 810, change parameters 820, and output parameters 830 might be combined and provided to a single hash algorithm 840 when generates a single hash value 850 based on all three parameters.

Thus, embodiments may provide a tool to significantly improve performance of new applications because unnecessary processing can be identified and eliminated. It helps developers better understand what happens within the code they are reusing. They can then take appropriate actions to optimize the performance of an application.

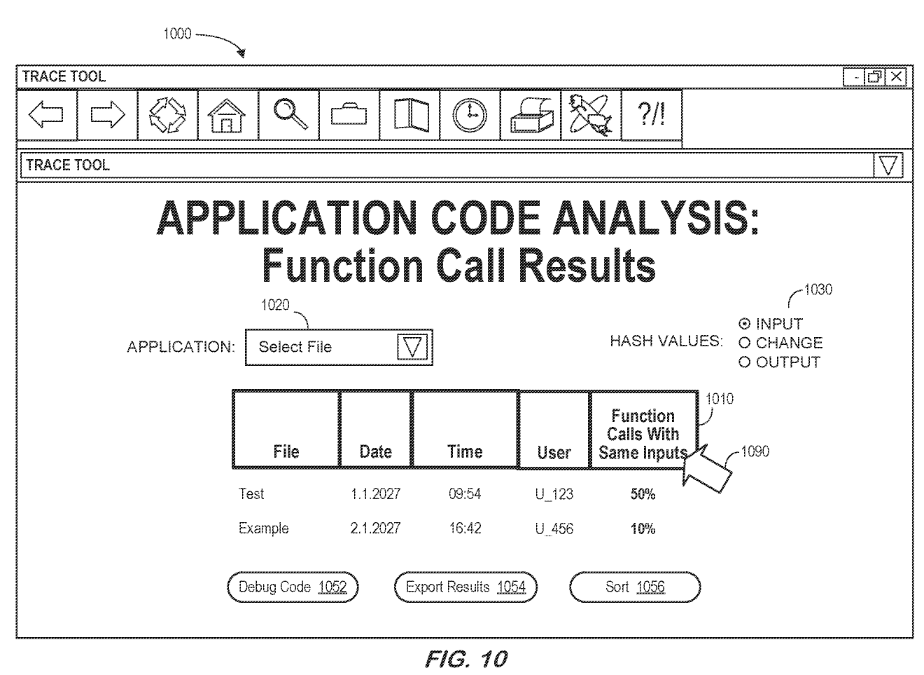

FIG. 10 is an application code analysis results display 1000 according to some embodiments. The display 1000 includes a results table 1010 including, for various files, a date and time of analysis, a user identifier, a percentage value indicating function calls with the same parameters, etc. Selection of an element in the results table 1010 (e.g., via a touchscreen or computer mouse pointer 1090) may result in the display of additional information. The display 1000 may also be used by a developer to select a file 1020 (containing the code to be analyzed), select which hash values should be compared 1030, select a “Debug Code” icon 1052 run a trace tool, select an “Export Results” icon 1054 to save the results (e.g., for a spreadsheet application, select a “Sort” icon 1056 to re-arrange the table 1010 (e.g., based on the percentages), etc. When looking for identical calls, the system looks for a high number of identical calls, such as a threshold value of 50% or any other amount. The help here is to know that there is a high percentage (e.g., 50% or higher) of code that is executed to calculate the same results over and over again. This can then be eliminated to improve the performance of an application (e.g., by executing each unique function once and only once).

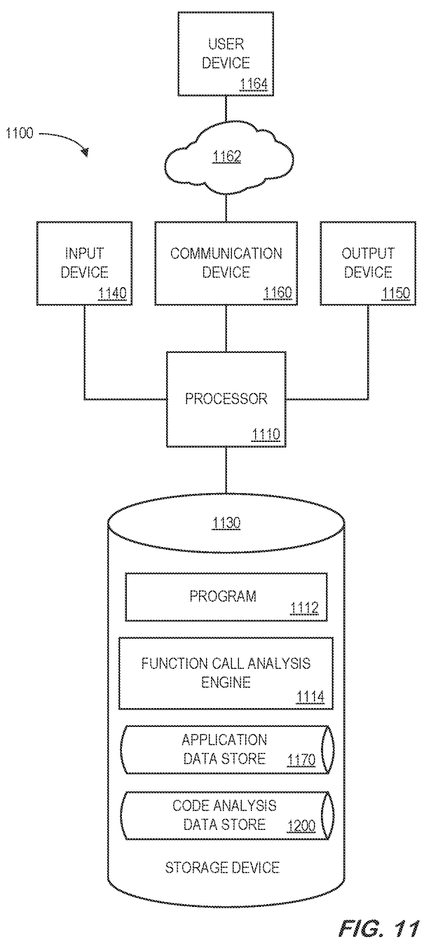

Note that the embodiments described herein may be implemented using any number of different hardware configurations. For example, FIG. 11 is a block diagram of an apparatus or platform 1100 that may be, for example, associated with the system 300 of FIG. 3 (and/or any other system described herein). The platform 1100 comprises a processor 1110, such as one or more commercially available Central Processing Units (“CPUs”) in the form of one-chip microprocessors, coupled to a communication device 1160 configured to communicate via a communication network 1162. The communication device 1160 may be used to communicate, for example, with one or more remote users (e.g., application programmer) devices 1164, suggestion engines, administrator platforms, etc. The platform 1100 further includes an input device 1140 (e.g., a computer mouse and/or keyboard to input data mappings and/or threshold rules) and/or an output device 1150 (e.g., a computer monitor to render a display, transmit recommendations and alerts, and/or create reports about analysis results, feedback to improve system performance, etc.).

The processor 1110 also communicates with a storage device 1130. The storage device 1130 may comprise any appropriate information storage device, including combinations of magnetic storage devices (e.g., a hard disk drive), optical storage devices, mobile telephones, and/or semiconductor memory devices. The storage device 1130 stores a program 1112 and/or a function call analysis engine 1114 for controlling the processor 1110. The processor 1110 performs instructions of the programs 1112, 1114, and thereby operates in accordance with any of the embodiments described herein. For example, the processor 1110 may identify a first function call in advanced programming language code and calculate a first hash value for the first function call (e.g., using SHA-1, MD5, or any other appropriate algorithm). The hash values might be calculated by the processor 1110, for example, based on input, change, and/or output parameters of the function calls. The processor 1110 can then automatically determine that a second function call in the advanced programming language code is potentially identical to the first function call based on the first hash value and a second hash value calculated for the second function call. An indication of the determination is then transmitted by the processor 1110 to a user in connection with a trace tool.

The programs 1112, 1114 may be stored in a compressed, uncompiled and/or encrypted format. The programs 1112, 1114 may furthermore include other program elements, such as an operating system, clipboard application, a database management system, and/or device drivers used by the processor 1110 to interface with peripheral devices.

As used herein, information may be “received” by or “transmitted” to, for example: (i) the platform 1100 from another device; or (ii) a software application or module within the platform 1100 from another software application, module, or any other source.

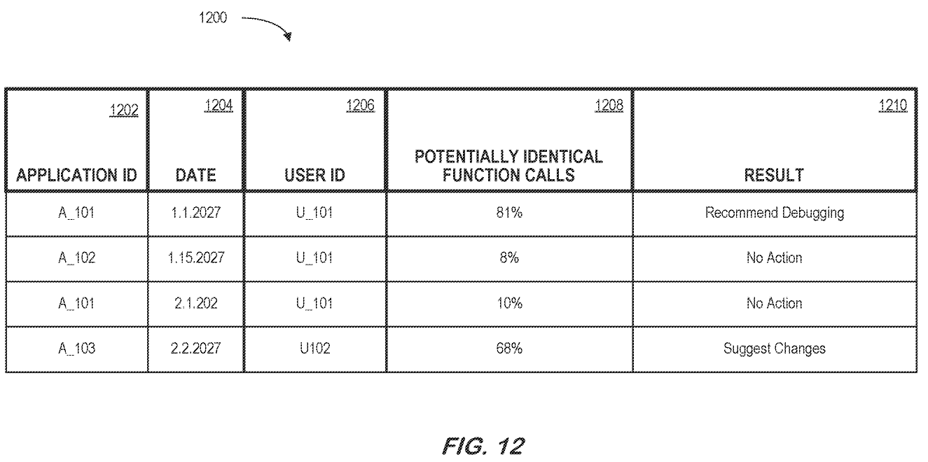

In some embodiments (such as the one shown in FIG. 11), the storage device 1130 further stores an application data store 1170 and a code analysis data store 1200. An example of a database that may be used in connection with the platform 1100 will now be described in detail with respect to FIG. 12. Note that the database described herein is only one example, and additional and/or different information may be stored therein. Moreover, various databases might be split or combined in accordance with any of the embodiments described herein.

Referring to FIG. 12, a table is shown that represents the code analysis data store 1200 that may be stored at the platform 1100 according to some embodiments. The table may include, for example, entries identifying applications that have been analyzed by the system. The table may also define fields 1202, 1204, 1206, 1208, 1210 for each of the entries. The fields 1202, 1204, 1206, 1208, 1210 may, according to some embodiments, specify: an application identifier 1202, a date 1204, a user identifier 1206, potentially identical function calls 1208, and a result 1210. The code analysis data store 1200 may be created and updated, for example, when a new analysis is triggered by a programmer, results are updated by the system, etc.

The application identifier 1202 might be a unique alphanumeric label that is associated with application code being analyzed. The date 1204 may indicate when the analysis was performed. The user identifier 1206 may indicate the programmer who requested the review be performed. The potentially identical function calls 1208 might represent code that is being wastefully executed. The result 1210 might indicate, for example, that debugging is recommended, no action be performed, that changes are automatically proposed to improve the code, etc.

In this way, embodiments may provide function call analysis of application code in a secure, automatic, and efficient manner. A trace tool may significantly improve the performance of new applications as a result of unnecessary processing being identified and eliminated. Embodiments may help developers better understand what happens in the code that is being re-used. The developer can then take appropriate actions to optimize performance of an application. Embodiments may also significantly simplify the implementation and let this tool be used in a productive customer environment as the overhead (e.g., CPU and memory consumption) will be reasonable.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

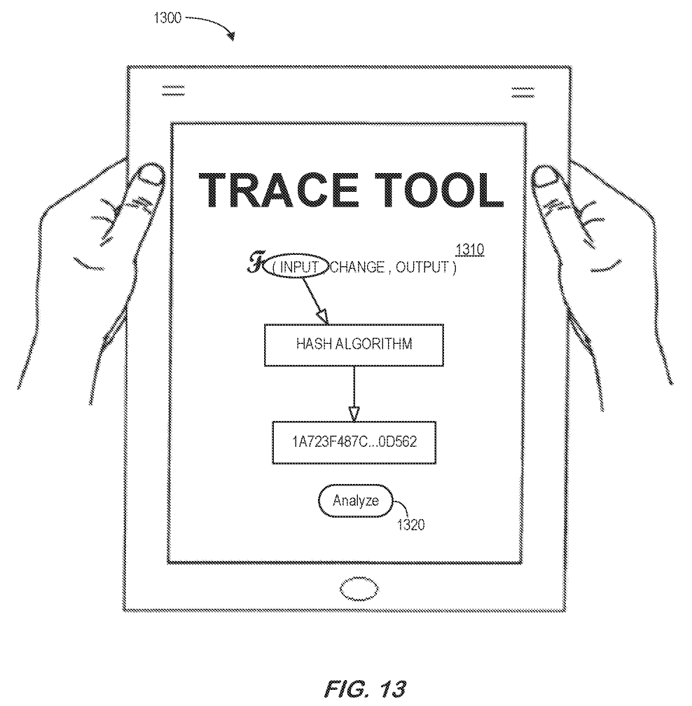

Although specific hardware and data configurations have been described herein, note that any number of other configurations may be provided in accordance with some embodiments of the present invention (e.g., some of the information associated with the databases described herein may be combined or stored in external systems). Moreover, although some embodiments are focused on particular types of business applications, any of the embodiments described herein could be applied to any other type of application. Moreover, the displays shown herein are provided only as examples, and any other type of user interface could be implemented. For example, FIG. 13 illustrates a tablet computer 1300 providing a trace tool display 1310 including a function call, a hash value, etc. The display 1310 might be used, for example, to investigate aspects of an application problem using an “Analyze” icon 1320.

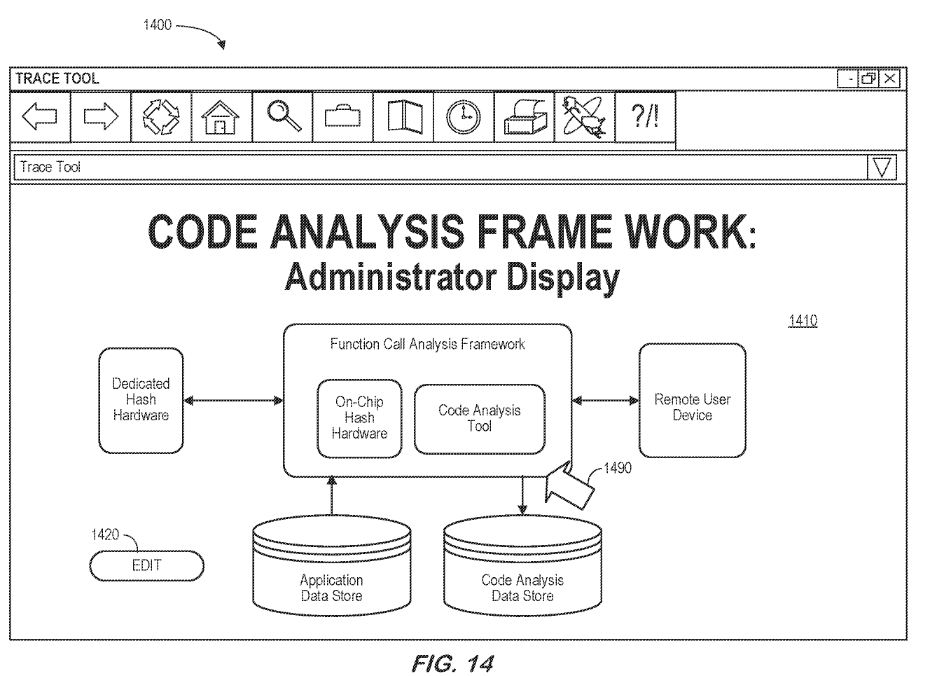

FIG. 14 is an operator or administrator display in accordance with some embodiments. The display 1400 includes a graphical representation 1410 of a function call analysis framework in accordance with any of the embodiments described herein. Selection of an element on the display 1400 (e.g., via a touchscreen or computer pointer 1490) may result in display of a pop-up window containing more detailed information about that element and/or various options (e.g., customized threshold details, mappings to database, result report summaries, etc.). Selection of an “Edit” icon 1420 may also let an operator or administrator adjust the operation of the system (e.g., to change system mappings, adjust hash pattern rules or logic, etc.).

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

1. A system, comprising:
an application data store containing advanced programming language code that includes function calls; and
a code analysis tool, coupled to the application data store, including:
a computer processor, and
a computer memory storing instructions that, when executed by the computer processor, cause the code analysis tool to:
access the advanced programming language code from the application data store,
identify a first function call in the advanced programming language code,
calculate a first hash value for the first function call,
automatically determine that a second function call in the advanced programming language code is potentially identical to the first function call based on the first hash value and a second hash value calculated for the second function call, and
transmit an indication of the determination to a user in connection with a trace tool.

2. The system of claim 1, wherein the hash values are calculated based on input parameters of the function calls.

3. The system of claim 1, wherein the hash values are calculated based on change parameters of the function calls.

4. The system of claim 1, wherein the hash values are calculated based on output parameters of the function calls.

5. The system of claim 1, wherein a separate hash value is calculated for each of input, change, and output parameters of the function calls.

6. The system of claim 5, wherein each of the input, change, and output parameters comprise data structures with multiple fields.

7. The system of claim 6, wherein the hash values are associated with a mathematical function that maps data of any size to a fixed-size hash value comprising at least one of: (i) a Secure Hash Algorithm 1 (“SHA-1”) algorithm that produces a 20-byte hash message digest value, (ii) a Message Digest 5 (“MD5”) algorithm, (iii) a Cyclic Redundancy Check 32 (“CRC32”) algorithm, (iv) a Research and development in Advanced Communications technologies in Europe (“RACE”) Message Digest 160 (“RACEMD160”), and (v) a Tiger Tree Hash (“TTH”) algorithm.

8. The system of claim 1, wherein the hash values are calculated using dedicated hardware associated with the computer processor.

9. The system of claim 8, where the dedicated hardware is associated with password encryption.

10. The system of claim 1, wherein the advanced programming language code is associated with at least one of: (i) Advanced Business Application Programming (“ABAP”), (ii) a method’s call of an object, (iii) a Pascal function or procedure, (iv) a C programming language function, and (v) object-oriented programming methods which are part of an object.

11. A computer-implemented method, comprising:
accessing, by a computer processor of code analysis tool, advanced programming language code that includes function calls from an application data store;
identifying a first function call in the advanced programming language code;
calculating a first hash value for the first function call;
automatically determining that a second function call in the advanced programming language code is potentially identical to the first function call based on the first hash value and a second hash value calculated for the second function call; and
transmitting an indication of the determination to a user in connection with a trace tool.

12. The method of claim 11, wherein the hash values are calculated based on input parameters of the function calls.

13. The method of claim 11, wherein the hash values are calculated based on change parameters of the function calls.

14. The method of claim 11, wherein the hash values are calculated based on output parameters of the function calls.

15. One or more non-transitory computer-readable media storing computer-executable instructions that, when executed by a computing system, cause the computing system to perform comprising:
accessing, by a computer processor of code analysis tool, advanced programming language code that includes function calls from an application data store;
identifying a first function call in the advanced programming language code;
calculating a first hash value for the first function call;
automatically determining that a second function call in the advanced programming language code is potentially identical to the first function call based on the first hash value and a second hash value calculated for the second function call; and
transmitting an indication of the determination to a user in connection with a trace tool.

16. The media of claim 15, wherein a separate hash value is calculated for each of input, change, and output parameters of the function calls.

17. The media of claim 16, wherein each of the input, change, and output parameters comprise data structures with multiple fields.

18. The media of claim 15, wherein the hash values are associated with a mathematical function that maps data of any size to a fixed-size hash value comprising at least one of: (i) a Secure Hash Algorithm 1 (“SHA-1”) algorithm that produces a 20-byte hash message digest value, (ii) a Message Digest 5 (“MD5”) algorithm, (iii) a Cyclic Redundancy Check 32 (“CRC32”) algorithm, (iv) a Research and development in Advanced Communications technologies in Europe (“RACE”) Message Digest 160 (“RACEMD160”), and (v) a Tiger Tree Hash (“TTH”) algorithm.

19. The media of claim 15, wherein the hash values are calculated using dedicated hardware associated with password encryption.

20. The media of claim 15, wherein the advanced programming language code is associated with at least one of: (i) Advanced Business Application Programming (“ABAP”), (ii) a method’s call of an object, (iii) a Pascal function or procedures, (iv) a C programming language function, and (v) object-oriented programming methods which are part of an object.
